(19) United States
(12) Patent Application Publication
(10) Pub. No.: US 2010/0076770 A1
(43) Pub. Date: Mar. 25, 2010

(54) System and Method for Improving the Performance of Voice Biometrics

(76) Inventor: Veeru Ramaswamy, Jackson, NJ (US)

Correspondence Address: STOLL KEENON OGDEN PLLC, 2000 PNC PLAZA, 500 WEST JEFFERSON STREET, LOUISVILLE, KY, 40202-2828, US

(21) Appl. No.: 12/236,354

(22) Filed: Sep. 23, 2008

(51) Int. Cl. G10L 21/00

(52) U.S. Cl. 704/273; 704/E21.001

(57) ABSTRACT

A System and Method for Improving the Performance of Voice biometrics is provided wherein a digitized audio signal originating from at least one input client device is compressed (standards-based or proprietary) or uncompressed, the signal optionally being passed to a network which then passes the uncompressed signal to at least a voice biometrics engine and the compressed signal to a voice recorder. The signal is compressed using a compressor utilizing CELP-based technology such as MASC® technology and then sends the compressed signal optionally to a voice recorder where the signal is stored. The compressed signal is then sent to a decompressor which decompresses the signal and forwards the decompressed signal to a voice biometrics engine before being processed with or without a signal processing filter. The voice biometrics engine receives the signal and upon performing the enrollment and/or authentication/verification functions on the signal, thereby outputting one or more voice prints, a verification score, and a confidence score.

### BRIEF DESCRIPTION OF THE DRAWINGS

FIG. 1 shows a graphical representation of FAR, FRR and EER relevant to embodiments of a System and Method for Improving the Performance of Voice Biometrics.

FIG. 1A shows an embodiment of a System and Method for Improving the Performance of Voice Biometrics in PSTN and VoIP networks wherein a G.711/PCM signal is utilized.

FIG. 1B shows an embodiment of a System and Method for Improving the Performance of Voice Biometrics in PSTN and VoIP networks wherein a standards-based compressed signal is utilized.

FIG. 1C shows an embodiment of a System and Method for Improving the Performance of Voice Biometrics in an IP Network wherein a compression engine such as MASC® is utilized within an input client.

FIG. 2 shows scenario 1 being a prior art baseline configuration of an existing Voice Biometrics system wherein a G.711/PCM signal is utilized without compression for enrollment and verification.

FIG. 3 shows scenario 2 being an embodiment of a System and Method for Improving the Performance of Voice Biometrics wherein a G.711/PCM signal is utilized with compression for enrollment and without compression for verification.

FIG. 4 shows scenario 3 being an embodiment of a System and Method for Improving the Performance of Voice Biometrics wherein a G.711/PCM signal is utilized without compression for enrollment and with compression for verification.

FIG. 5 shows scenario 4 being an embodiment of a System and Method for Improving the Performance of Voice Biometrics wherein a G.711/PCM signal is utilized with compression for both enrollment and verification.

### MULTIPLE EMBODIMENTS AND ALTERNATIVES

Multiple embodiments of a System and Method for Improving the Performance of Voice Biometrics 10 are provided. Applicant's related U.S. patent application, Ser. No. 12/168,985, teaches and claims a system and method for improving the performance of speech analytics and word spotting systems. Because the previously-filed teachings for speech analytics engines are relevant to the instant teachings for voice biometrics engines, U.S. patent application Ser. No. 12/168,195 is incorporated by reference herein in its entirety.

Voice biometrics is an application service of enrollment and verification that functions to correctly identify and verify the spoken words and speech of a speaker. Embodiments are provided wherein the speaker is a human being engaged in producing sounds in the form of utterances which are recognized as speech, such as, for example, oral communication. The purpose of such voice biometrics functions is to authenticate speakers and, once authenticated, to authorize speakers to engage in further actions, decisions, functions and the like. Authentication of speakers occurs in a two-step process of speaker identification and speaker verification.

Speaker identification is the process of finding and attaching a speaker identity to the voice of a claimant being an unknown speaker. In embodiments including automated speaker identification, the claimant's voice is compared with stored voice samples in a database of voice models. If that comparison is favorable, the claimant's status changes to that of an identified speaker. With regard to the several Figures and further teachings herein, Enrollment is a process in authentication which captures the nuances of any particular voice.

Verification is the process of determining whether or not a claimant has the identity asserted by the claimant. In embodiments including automated speaker verification, the claimant's newly-inputted voice print is compared on a one-to-one basis with a stored voice print (voice signature) for the identity claimed by the claimant. The stored voice print is stored in the database of voice models. Authorization of a particular speaker to access the system is performed after the verification process is completed by the system.

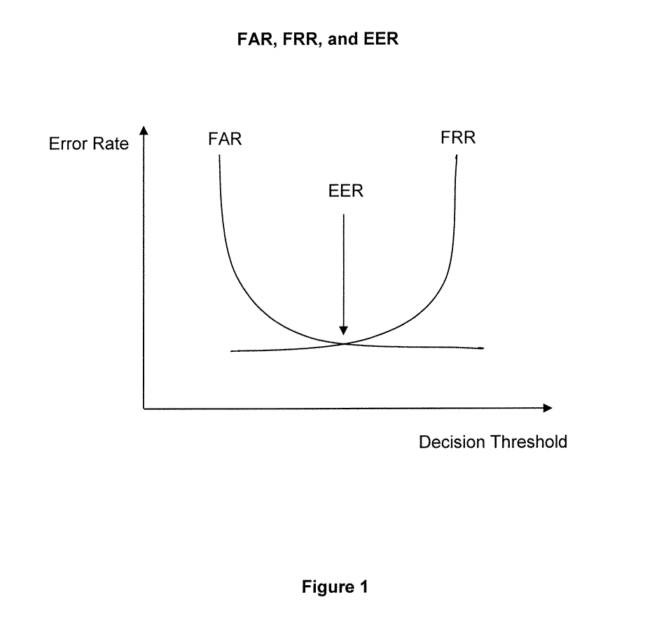

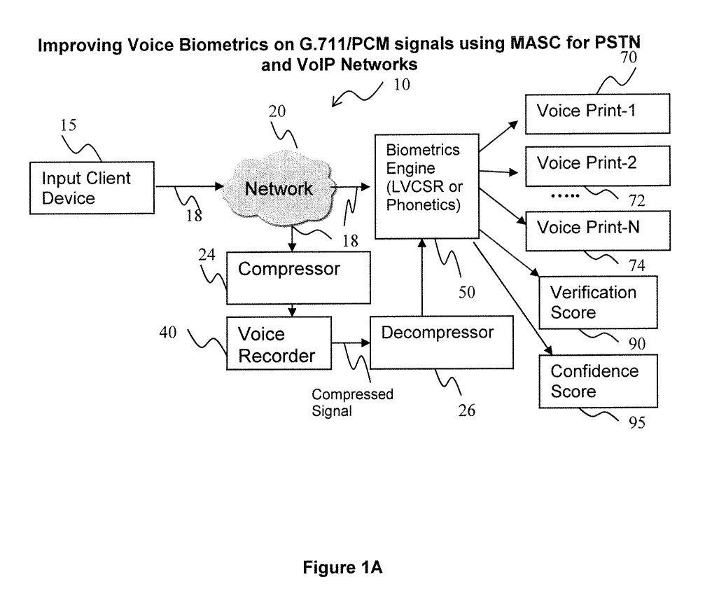

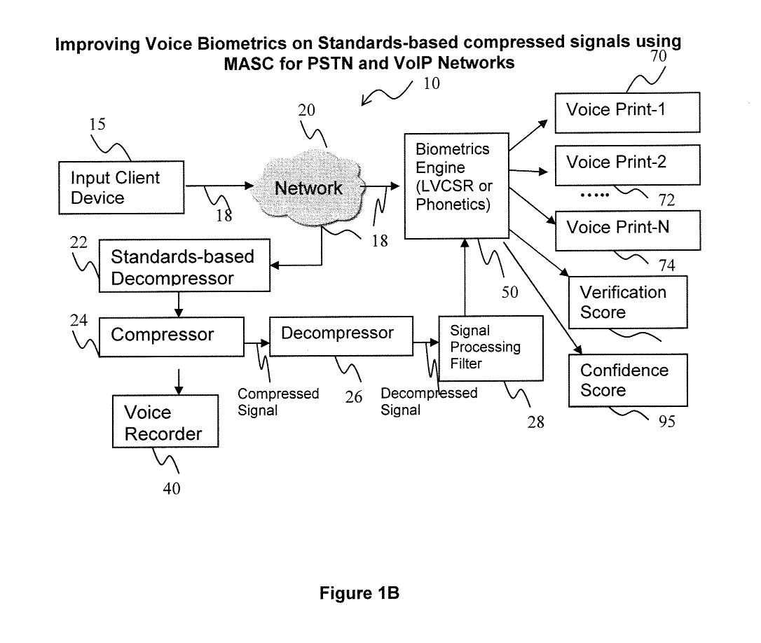

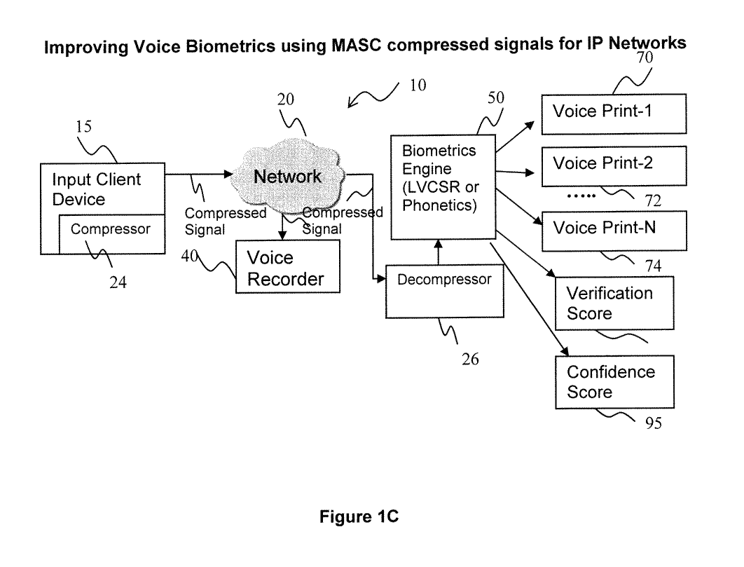

A system and method for improving voice biometrics 10 comprises multiple embodiments and alternatives. For embodiments related to traditional Public Switched Telephone Networks (PSTN), Integrated Services Digital Network (ISDN), wireless, or Internet Protocol (IP) networks, enrollment occurs as follows: voice signals 18 are selected from the group PCM (with sampling rate selected from the group 8, 11, 16, 22, 32, 44, 48 KHz and bit resolution selected from the group 8, 16, 32, 64), G.711 (selected from the group a-law, u-law) (FIG. 1A), or any standards-based compressed signal such as, for example, G.72x, GSM-AMR and CDMA-EVRC (FIG. 1B), or proprietary compressed such as, for example, CELP-based MASC® (FIG. 1C). In further detail the signal 18 is selected from the group:

1) PCM (with sampling rate selected from the group 8, 11, 16, 22, 32, 44, 48 KHz and bit resolution selected from the group 8, 16, 32, 64), G.711 (selected from the group a-law, u-law),

2) MASC® compressed and MASC® decompressed,

3) standards-based selected from the group; ITU-based: G.722, G.723, G.726, G.729; ETSI-based: GSM 6.10, GSM- AMR; CDMA-based: IS-95/CDMA-1x, IS-95/CDMA-3x; and EVDO-based: EVRC-A, EVRC-B, EVRC-AB, VMR.

The signal 18 originates from an input client device 15, which sends the signal 18 to a biometrics engine 50 which utilizes Large Vocabulary Continuous Speech Recognition (LVCSR) or phonetics, as desired. Embodiments include those wherein the signal 18 is sent from input client device 15 to a network 20 which then sends the signal 18 to the biometrics engine 50. The biometrics engine 50 performs speaker enrollment functions as described above and outputs at least one voice print 70 thereby completing the enrollment process.

For verification, the biometrics engine 50 further provides a verification score 90 known to be a metric for an identification of either a true speaker or an impostor, and known to be usually expressed as either a percentage or in a range of between negative one and positive one, as desired. The biometrics engine 50 also provides a confidence score 95. The confidence score 95 is known to be expressed as either a probability between zero and one or a percentage, as desired, and is a measure of the confidence of the system 10 in obtaining the verification score 90. Verification scores 90 are known to be derived depending on the infrastructure deployed, the network, and the like.

The voice biometrics engine 50 is selectably chosen, as desired, from the group LVCSR, Phonetics, text dependent, text independent. As such, the enrollment and identification/verification for biometrics engines 50 is performed differently as below:

For embodiments wherein the voice biometrics engine 50 is Large Vocabulary Continuous Speech Recognition-based, the LVCSR is typically based on a Hidden Markov Model (HMM) for training and recognition of spoken words. LVCSR-based voice biometrics engines 50 do not split the spoken words into phonemes for training and recognition. Instead, the engines 50 look for entire words, as is, for training and recognition.

For embodiments wherein the voice biometrics engine 50 is phonetic-based, the words are split into phoneme units or sometimes even into sub-phoneme units, as desired. Next, the voice biometrics engine 50 is trained with those phonemes to create a voice print 70-74 for a particular speaker.

For embodiments wherein the voice biometrics engine 50 is text dependent, text dependent speaker enrollment and verification is performed with a predefined utterance for both training (enrollment) and identification (verification) of the users.

For embodiments wherein the voice biometrics engine 50 is text independent, no such restriction exists.

Embodiments include systems 10 wherein the signals 18 are selectably, as desired, compressed and/or uncompressed. Further embodiments include those wherein a compression engine, referred to as a CODEC and having a compressor 24 and a decompressor 26, operates utilizing CELP-based technology such as MASC® technology as described in U.S. patent application Ser. No. 10/676,491, incorporated herein by reference. MASC® processing has been found to perform better with respect to verification score 90 in that higher true-identification scores and lower false-impostor scores are achieved. Likewise, MASC® processing has been found to perform better with respect to the confidence score 95. MASC® processing performs better due to the inherent noise reduction techniques that are incorporated into the MASC® compression algorithm which results in improving the scores discussed above.

With reference to FIG. 1, apart from true and impostor scores, biometric error scores are measured as follows: a False Acceptance Rate (FAR) is for when the system incorrectly identifies an impostor as a true speaker; and, a False Rejection Rate (FRR) is for when the system incorrectly rejects a true speaker. The graphical depiction in FIG. 1 of the intersection of the plots for FAR and FRR yields an Equal Error Rate (EER).

For embodiments utilizing G.711 signals, with their inherent noise, that are captured, MASC® performs noise reduction to enhance the verification and confidence scores 90, 95. By doing so, these MASC® compressed signals 18, when passed to the voice biometrics engine 50 after being decompressed, are found to yield Verification and Confidence scores 90, 95 superior to other systems utilizing non-MASC® schemes.

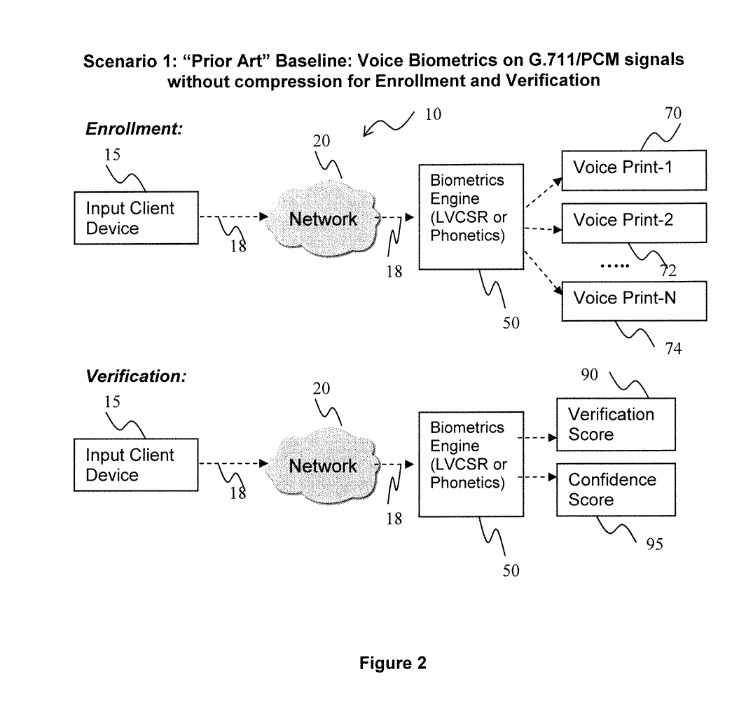

In further detail, FIG. 1A shows, in general, an example for the overall system 10, not meant to be limiting, of how a use of compression, as desired, fits in with the present embodiments. In particular, embodiments of a PCM/G.711 System for Improving the Performance of Voice Biometrics 10 comprise a digitized audio signal 18 originating from at least one input client device 15, being sent to a network 20 which sends the signal 18 to at least both a compressor 24 and a biometrics engine 50. The compressor 24 compresses the signal 18 and sends the compressed signal 18 to a voice recorder 40 which then sends the compressed signal 18 to decompressor 26 which decompresses the signal 18. The decompressor 26 sends the decompressed signal 18 to the voice biometrics engine 50. Note that in FIG. 2 the dashed line indicates that no compression is utilized in that particular signal path and that this FIG. 2 represents the prior art. Going on and with continued reference to all the Figures, the biometrics engine 50 outputs at least one voice print shown as “voice print-1” 70, “voice print-2” 72 and up to “voice print-N” 74 wherein the N is greater than or equal to three, a verification score 90, and a confidence score 95.

The network 20 is selected, as desired, from the group PSTN, ISDN, IP (VoIP), wired, wireless. Embodiments provide that the compression engine comprises compressor 24 and decompressor 26 and utilizes MASC® technology. The digitized audio signal 18 of FIG. 1A is selected, as desired, from the group PCM, G.711.

With respect to the system described above and shown in FIG. 1A, a Method for Improving the Performance of Voice Biometrics 10 comprises the steps of:

1. An input client device 15 sends digitized audio signals 18 to a network 20 as desired.

2a. Either: The network 20 sends the signals 18 to at least a biometrics engine 50 chosen from the group LVCSR, phonetics, text dependent, text independent, as desired.

2b. Or: as desired, and only for embodiments utilizing compression, the network 20 sends the signal 18 to a compressor 24 which compresses the signal 18 and sends the compressed signal 18 to a voice recorder 40 which then sends the compressed signal 18 to a decompressor 26 which then sends the decompressed signal 18 to at least a biometrics engine 50 chosen from the group LVCSR, phonetics, text dependent, text independent, as desired.

3. For enrollment, upon completion of either step 2a or 2b, the biometrics engine 50 performs enrollment procedures for speaker identification and verification and outputs at least one voice print 70 thereby completing the enrollment process.

4. For verification, upon completion of either step 2a or 2b, as desired, the biometrics engine 50 further provides a verification score 90 wherein true identification scores (true speaker identified correctly) and impostor scores (impostor identified correctly) are measured along with the cross cases of False Acceptance Rate (FAR) and False Rejection Rate (FRR), the intersection of which yields the Equal Error Rate (EER). The biometrics engine 50 also provides a confidence score 95 which is known to indicate the confidence level of the biometrics engine 50 concerning the computed verification score 90.

By way of further example, not meant to be limiting and considering the signal as received by the biometrics engine, A Method for Improving the Performance of Voice biometrics comprises the steps of:
(a) For enrollment, the biometrics engine 50 receives a digitized audio signal 18, the signal 18 being decompressed or uncompressed, from one or more input client devices 15, directly or through a network 20,

The compressor 24 receives the signal 18 from the input client device 15, directly or through a network 20, thereby compressing the signal 18 and sends the compressed signal 18 to a voice recorder 40,

The voice recorder 40 sends the compressed signal 18 to a decompressor 26 which decompresses the signal 18,

The decompressor 26 sends the decompressed signal 18 to the biometrics engine 50,

If the signal 18 is uncompressed, the biometrics engine 50 receives the signal 18 from the input client device 15 directly or through the network 20,
The biometrics engine 50 performs speaker identification functions and outputs at least one voice print 70 thereby completing the enrollment process; and,
(b) For verification, the biometrics engine 50 receives a digitized audio signal 18, the signal 18 being decompressed or uncompressed, to a biometrics engine 50 directly or through a network 20,

The compressor 24 receives the signal 18 from the input client device 15, directly or through a network 20, thereby compressing the signal 18 and sends the compressed signal 18 to a voice recorder 40,

The voice recorder 40 sends the compressed signal 18 to a decompressor 26 which decompresses the signal 18,

The decompressor 26 sends the decompressed signal 18 to the biometrics engine 50,

If the signal 18 is uncompressed, the biometrics engine 50 receives the signal 18 from the input client device 15 directly or through the network 20,
The biometrics engine 50 further provides a verification score 90 and a confidence score 95 wherein true and impostor scores are measured by False Acceptance Rate (FAR) and False Rejection Rate (FRR), further yielding an Equal Error Rate (EER).
The Method taught above includes embodiments utilizing various choices and combinations within the system 10 as taught above. For example, not meant to be limiting, embodiments of the system and method 10 include those wherein the voice biometrics engine 50 is selectably chosen, as desired, from the group LVCSR, phonetics, text dependent, text independent, as desired. The network 20 is selected, as desired, from the group PSTN, ISDN, IP (VoIP), wired or wireless. Embodiments provide that both of the compressor 24 and decompressor 26, where present, utilize MASC® technology. Furthermore, embodiments include those wherein the digitized audio signal 18 is selected, as desired, from the group PCM, G.711. Embodiments include those wherein the signal processing filter 28 receives the decompressed signal 18 from the decompressor 24 and processes the decompressed signal 18 thereby enhancing the voice quality, the signal processing filter 28 forwarding the enhanced decompressed signal 18 to the biometrics engine 50.

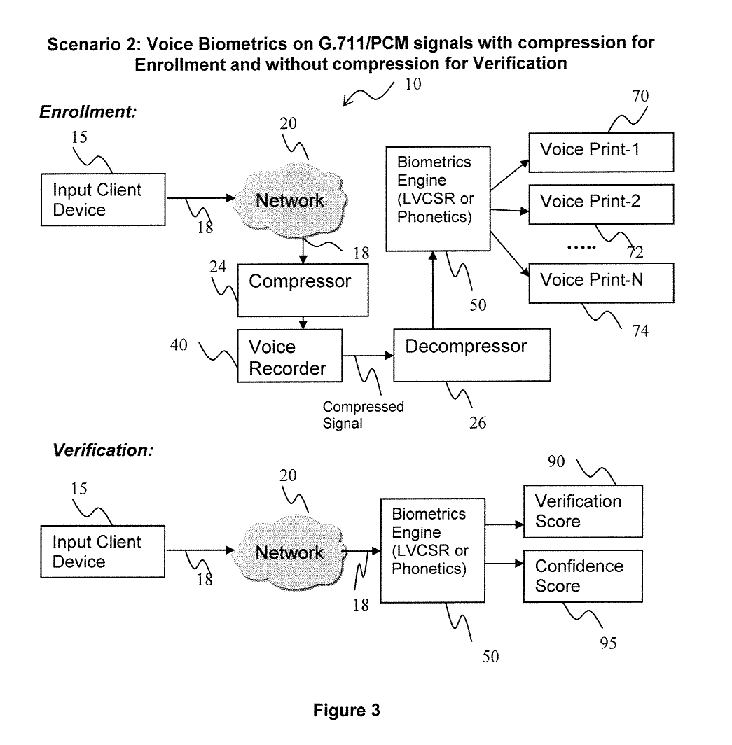

Referring to FIG. 1B, embodiments include those wherein the digitized audio signal 18 is captured by the voice recorder 40 and recorded natively in the standards-based format and/or the MASC® format. Embodiments further include those having standards-based digitized audio signals to include G.72x signals, which are traditionally used in telephony based on IP or PSTN networks. Embodiments are further provided wherein the standards-based digitized audio signals are selectably chosen, as desired, from the group G.722, G.723, G.726, G.729, GSM-AMR, CDMA-EVRC. The standards-based digitized audio signal originating from input client device 15 is sent, for embodiments including a network 20 and as desired, to a network 20, and further, or sent directly if no network 20 is used, sent to a standards-based decompressor 22 as shown in FIG. 1B before being sent to the compressor 24. FIG. 2 is a prior art baseline for novel FIG. 1A. Similarly, a novel baseline case is identified for FIG. 1B, incorporating the novel scenarios of FIGS. 3-5.

For such embodiments, to improve/enhance the Verification and Confidence scores 90, 95, MASC® technology as described in U.S. patent application Ser. No. 10/676,491, in combination with other post-processing filtering, such as signal processing filter 28, performs or provides better Verification and Confidence scores 90, 95 than the original standards-based signals. Embodiments include those wherein a voice print which was originally formed by the voice biometrics engine 50, is again processed using MASC® technology along with signal processing filter 28.

As discussed above previously in teaching the PCM embodiments, the MASC® compressed signals, when passed to the voice biometrics engine 50 after being decompressed, are found to yield better Verification and Confidence scores 90, 95 than non-MASC® schemes. Even higher Verification and Confidence scores 90, 95 are achieved when utilizing embodiments having MASC® processing combined with signal processing filter 28 apart from the compressor 24, voice recorder 40 and decompressor 26, in that order. For example, not meant to be limiting, MASC® processing is combined with the signal processing filter 28 and the signal processing filter 28 is introduced between the decompressor 26 and the biometrics engine 50.

The use of MASC® processing in noise reduction applies not only to G.711 or PCM embodiments as above, but also to embodiments utilizing standards-based means to include G.72x means. As written above, for embodiments utilizing and capturing G.711 or PCM signals, with their inherent noise, MASC® performs noise reduction to enhance the performance by improving the Verification and Confidence scores 90, 95. In contrast, for embodiments utilizing G.72x compression schemes, there are two forms of noise that typically appear embedded within the signals. The first form of noise is ambient noise that is recorded when the recording is being made. Such ambient noise is typically due to car noise, street noise, babble noise and other forms of background sounds. The second form of noise is quantization noise typically occurring when digitizing an audio signal or when the audio signal is reduced to a lower resolution, such as, for example, from 8-bit samples to 4-bit or 2-bit samples. Apart from the ambient noise, which is handled inherently by the MASC® technology, the quantization noise is typically injected as artifacts while performing a standards-based means compression. For best Verification and Confidence scores 90, 95, the quantization noise is taken care of by a combination of compressor 24 and filter 28; such as, for example, a compressor 24 utilizing MASC® technology combined with a signal processing filter 28.

With continued reference to FIGS. 1A, 1B, 3, 4 and 5, once again, FIG. 2 is a prior art baseline for novel FIG. 1A. Similarly, a novel baseline case is identified for FIG. 1B, incorporating the scenarios of FIGS. 2-5.

System 10 provides that where present and with reference to the Figures, each of the compressor 24, voice recorder 40, decompressor 26, and biometrics engine 50 are placed into multiple groups wherein each is in any of the separated groups and/or all the separated groups being either physically collocated or each of the separated groups being remotely located from the others or all of the groups are separated even merely by function. For example, not meant to be limiting, an embodiment is provided wherein the compressor 24, and the voice recorder 40, are in one group and the decompressor 26, and voice biometrics engine 50 are placed into another group.

With reference to FIG. 1B and with respect to the standards-based means system 10 taught above, a Method for Improving the Performance of Voice biometrics comprises the steps of:

1. Providing a digitized standards-based means audio signal 18 originating from one or more input client devices 15, the signal 18 being passed to a network 20.

2. The signal 18 being then received from the network 20 by a standards-based decompressor 22.

3. The standards-based decompressor 22 decompressing the compressed standards-based means signal 18 thereby yielding a decompressed PCM signal, the standards-based decompressor 22 then sending the decompressed PCM signal to a compressor 24.

4. The compressor 24 compressing the decompressed PCM signal and sending the compressed signal to a voice recorder 40.

5. The voice recorder 40 sending the compressed signal to a decompressor 26.

6. The decompressor 26 decompressing the signal and sending the decompressed signal to a signal processing filter 28 yielding a processed PCM WAV signal.

7. The signal processing filter 28 sending the processed PCM WAV signal to a voice biometrics engine 50.

8. The voice biometrics engine 50 creating a voice print 70-74, a verification score 90 and a confidence score 95 upon receiving the processed signal.

By way of further example, not meant to be limiting, a Method for Improving the Performance of Voice biometrics comprising the steps of:
(a) For enrollment, the biometrics engine 50 receives a decompressed digitized audio signal 18, the signal 18 being standards-based or proprietary, from one or more input client devices 15, directly or through a network 20,

If the decompressed signal 18 is proprietary, a standards-based decompressor 22 receives the signal 18 from the input client device 15, directly or through a network 20, thereby decompressing the standards-based signal 18 and sends the decompressed signal 18 to a compressor 24,
The compressor 24 compresses the signal 18 and sends the signal 18 to a voice recorder 40,
The voice recorder 40 sends the compressed signal 18 to a decompressor 26 which decompresses the signal 18,
The decompressor 26 sends the decompressed signal 18 to a signal processing filter 28,
The signal processing filter 28 sends the signal 18 to a biometrics engine 50,

If the decompressed signal 18 is standards-based, the biometrics engine 50 receives the decompressed signal 18 from the input client device 15 directly or through the network 20,

The biometrics engine 50 performs speaker identification functions and outputs at least one voice print 70 thereby completing the enrollment process; and,
(b) For verification, the biometrics engine 50 receives a decompressed digitized audio signal 18, the signal 18 being standards-based or proprietary, from one or more input client devices 15, directly or through a network 20,

If the decompressed signal 18 is proprietary, a standards-based decompressor 22 receives the signal from the input client device 15, directly or through a network 20, thereby decompressing the standards-based signal 18 and sends the decompressed signal 18 to a compressor 24,
The compressor 24 compresses the signal 18 and sends the signal 18 to a voice recorder 40,
The voice recorder 40 sends the compressed signal 18 to a decompressor 26 which decompresses the signal 18,
The decompressor 26 sends the decompressed signal 18 to a signal processing filter 28,
The signal processing filter 28 sends the signal 18 to a biometrics engine 50,

If the decompressed signal 18 is standards-based, the biometrics engine 50 receives the decompressed signal 18 from the input client device 15 directly or through the network 20,

The biometrics engine 50 further provides a verification score 90 and a confidence score 95 wherein true and impostor scores are measured by False Acceptance Rate (FAR) and False Rejection Rate (FRR), further yielding an Equal Error Rate (EER).

The voice biometrics engine 50 is selectably chosen, as desired, from the group LVCSR, Phonetics, text dependent, text independent. The network 20 is selected, as desired, from the group PSTN, ISDN, IP, wired, wireless. Embodiments provide that both the compressor 24 and the decompressor 26 utilize MASC® technology. With continued reference to FIG. 1B, embodiments of the system and method 10 include those wherein the standards-based means is selected from the group G.722, G.723, G.726, G.729, GSM-AMR, CDMA-EVRC. Furthermore, the function of the compressor 24 is incorporated within, or physically separate from and in any order, as desired, the voice recorder 40.

With continued reference to FIG. 1B, the standards-based means system 10 provides that each of the voice recorder 40, standards-based decompressor 22, compressor 24, decompressor 26, signal processing filter 28 and voice biometrics engine 50 are placed into multiple groups wherein each is in any of the separated groups and all the separated groups being either physically collocated or each of the separated groups being remotely located from the others or all of the groups are separated even merely by function. For example, not meant to be limiting, an embodiment is provided wherein the voice recorder 40, standards-based decompressor 22, and the compressor 24 are in one group and the decompressor 26, filter 28, and voice biometrics engine 50 are in another group, thereby comprising two separate groups. Going on with this example, further embodiments include those wherein the two groups are physically collocated, such that the two groups are placed within a single physical structure, by either physical location or even merely by function. By way of further detail example with respect to this example, other embodiments include those wherein the two groups are remotely located such that the first group is physically separate from second group.

With reference to FIG. 1C and in the case of an IP network only, instead of using the G.72X means signals of FIG. 1B, embodiments embed the compression engine, such as, for example, MASC® technology, within the device 15 itself and thereby offer a complete end-to-end compression-based biometrics solution.

As shown in FIG. 1C, an embodiment of a System and Method for Improving the Performance of Voice Biometrics for an IP network is provided using a proprietary compression engine made up of a compressor 24 and a decompressor 26. As desired, the compression engine incorporates MASC® technology.

In further detail, with reference to FIG. 1C, embodiments of a System for Improving the Performance of Voice Biometrics 10 comprise a compressed digitized audio signal 18 originating from at least one input client device 15 further comprising hardware or software performing at least the function of a compressor 24 being integrated within device 15. The compressed signal 18 is sent from the device 15 to a network 20 which sends the compressed signal 18 to at least both a decompressor 26 and a voice recorder 40. The decompressor 26 decompresses the signal 18 and sends the compressed signal 18 to a biometrics engine 50 which then outputs at least one voice print shown as “voice print-1” 70, “voice print-2” 72 and up to “voice print-N” 74 wherein the N is greater than or equal to one, a verification score 90, and a confidence score 95.

With reference to FIG. 2, a prior art baseline scenario 1 is presented for enrollment and verification. Scenario 1 is seen to be differentiated from the system illustrated in FIG. 1A in that no compressor, no voice recorder, and no decompressor are provided in the embodiment shown in FIG. 2. As such, the embodiments of FIG. 1A are novel over the system of FIG. 2 in their utilization of compressor, voice recorder, and decompressor. In particular, the enrollment phase of FIG. 2 shows that enrollment/training occurs as input client device 15 outputs a digitized audio signal 18 to a network 20. The network 20 sends the signal 18 to at least the biometrics engine 50 which operates on the signal and outputs at least one voice print, being illustrated as “voice print-1” 70, “voice print-2” 72 up to “voice print-N” 74.

Continuing with reference to the verification phase of FIG. 2, verification occurs as input client device 15 outputs a digitized audio signal 18 to a network 20. The network 20 sends the signal 18 to the biometrics engine 50 which operates on the signal and outputs a verification score 90 and a confidence score 95.

With reference to FIG. 3, scenario 2 is an embodiment of a System for Improving the Performance of Voice Biometrics 10 wherein a G.711/PCM signal 18 is utilized with compression for enrollment and without compression for verification. In particular, the enrollment phase of FIG. 3 shows an embodiment providing that enrollment occurs as input client device 15 outputs a digitized audio signal 18 to a network 20. The network 20 sends the signal 18 to the compressor 24 which sends a compressed signal 18 to the voice recorder 40 which sends a compressed signal on to the decompressor 26. The decompressor 26 decompresses the signal 18 and sends the decompressed signal 18 to the biometrics engine 50 which operates on the signal and outputs at least one voice print, being illustrated as “voice print-1” 70, “voice print-2” 72 up to “voice print-N” 74.

Continuing with reference to the verification phase of FIG. 3, an embodiment provides that verification occurs as input client device 15 outputs a digitized audio signal 18 to a network 20. The network 20 sends the signal 18 to the biometrics engine 50 which operates on the signal and outputs a verification score 90 and a confidence score 95.

With reference to FIG. 3, for scenario 2, an embodiment of a Method for Improving the Performance of Voice Biometrics 10 wherein a G.711/PCM signal is utilized with compression for enrollment and without compression for verification is presented. In particular, the enrollment phase of FIG. 3 shows an embodiment providing that enrollment occurs in the steps of:

1) Input client device 15 outputs a digitized audio signal 18 to a network 20.

2) The network 20 sends the signal 18 to the compressor 24.

3) The compressor 24 sends a compressed signal 18 to the voice recorder 40.

4) The voice recorder 40 sends a compressed signal to the decompressor 26.

5) The decompressor 26 decompresses the signal 18 and sends the decompressed signal 18 to the biometrics engine 50.

6) The biometrics engine 50 operates on the signal and outputs at least one voice print, being illustrated as “voice print-1” 70, “voice print-2” 72 up to “voice print-N” 74.

Continuing with reference to the verification phase of FIG. 3, an embodiment provides that verification occurs in the steps of:

7) input client device 15 having previously output a digitized audio signal 18 to a network 20, the network 20 sends the signal 18 (dashed line representation here indicates that no compression is utilized) to the biometrics engine 50.

8) The biometrics engine 50 operates on the signal and outputs a verification score 90 and a confidence score 95.

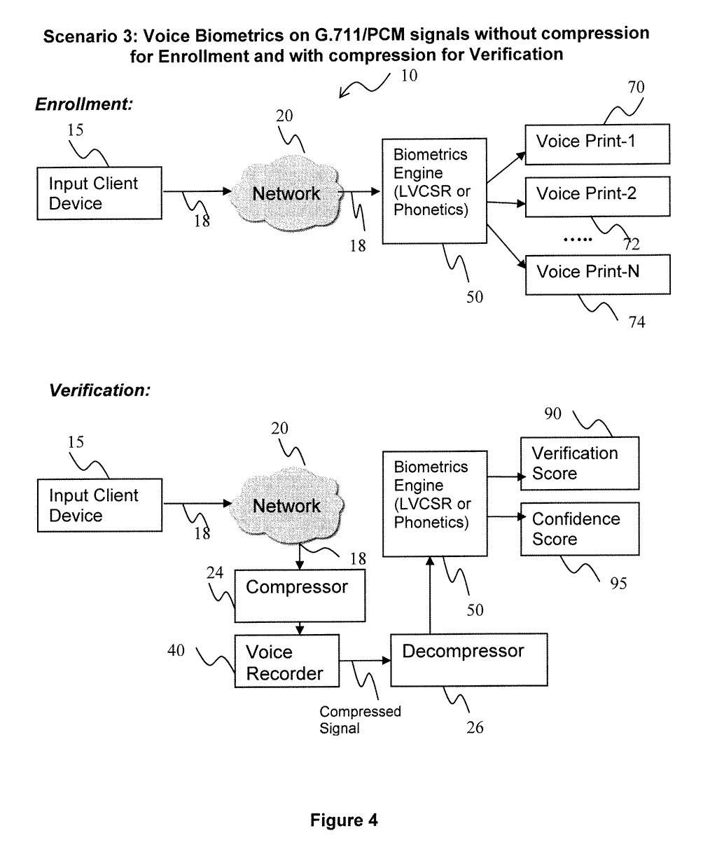

With reference to FIG. 4, for scenario 3, an embodiment of a System for Improving the Performance of Voice Biometrics wherein a G.711/PCM signal is utilized without compression for enrollment and with compression for verification. In particular, the enrollment phase of FIG. 4 shows an embodiment providing that enrollment occurs as input client device 15 outputs a digitized audio signal 18 to a network 20. The network 20 sends the signal 18 to the biometrics engine 50 which operates on the signal and outputs at least one voice print, being illustrated as “voice print-1” 70, “voice print-2” 72 up to “voice print-N” 74.

Continuing with reference to the verification phase of FIG. 4, an embodiment provides that verification occurs as input client device 15 outputs a digitized audio signal 18 to a network 20. The network 20 sends the signal 18 to the compressor 24 which sends a compressed signal 18 to the voice recorder 40 which sends a compressed signal on to the decompressor 26. The decompressor 26 decompresses the signal 18 and sends the decompressed signal 18 to the biometrics engine 50 which outputs a verification score 90 and a confidence score 95.

With reference to FIG. 4, scenario 3 an embodiment provides a Method for Improving the Performance of Voice Biometrics wherein a G.711/PCM signal is utilized without compression for enrollment and with compression for verification. In particular, the enrollment phase of FIG. 4 shows an embodiment providing that enrollment occurs in the steps of:

1) Input client device 15 outputs a digitized audio signal 18 to a network 20.

2) The network 20 sends the signal 18 to the biometrics engine 50.

3) The biometrics engine 50 operates on the signal and outputs at least one voice print, being illustrated as “voice print-1” 70, “voice print-2” 72 up to “voice print-N” 74.

Continuing with reference to the verification phase of FIG. 4, an embodiment provides that verification occurs in the steps of:

4) input client device 15 having previously output a digitized audio signal 18 to a network 20, the network 20 sends the signal 18 to a compressor 24.

5) The compressor 24 sends a compressed signal 18 to the voice recorder 40.

6) The voice recorder 40 sends a compressed signal to the decompressor 26.

7) The decompressor 26 decompresses the signal 18 and sends the decompressed signal 18 to the biometrics engine 50.

8) The biometrics engine 50 operates on the signal and outputs a verification score 90 and a confidence score 95.

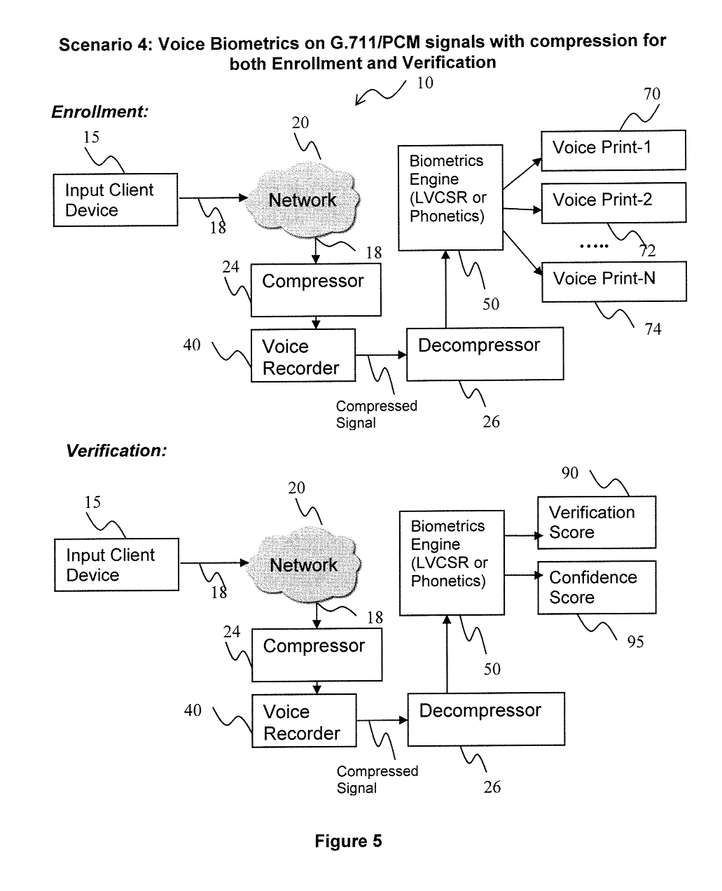

With reference to FIG. 5, scenario 4 is an embodiment of a System and Method for Improving the Performance of Voice Biometrics wherein a G.711/PCM signal is utilized with compression for both enrollment and verification. In particular, the enrollment phases of FIG. 5 shows an embodiment providing that enrollment occurs as input client device 15 outputs a digitized audio signal 18 to a network 20. The network 20 sends the signal 18 to the compressor 24 which sends a compressed signal 18 to the voice recorder 40 which sends a compressed signal on to the decompressor 26. The decompressor 26 decompresses the signal 18 and sends the decompressed signal 18 to the biometrics engine 50 which operates on the signal and outputs at least one voice print, being illustrated as “voice print-1” 70, “voice print-2” 72 up to “voice print-N” 74.

Continuing with reference to the verification phase of FIG. 5, an embodiment provides that verification occurs as input client device 15 outputs a digitized audio signal 18 to a network 20. The network 20 sends the signal 18 to the compressor 24 which sends a compressed signal 18 to the voice recorder 40 which sends a compressed signal 18 on to the decompressor 26. The decompressor 26 decompresses the signal 18 and sends the decompressed signal 18 to the biometrics engine 50 which outputs a verification score 90 and a confidence score 95.

With reference to FIG. 5, for scenario 4, an embodiment is provided of a Method for Improving the Performance of Voice Biometrics 10 wherein a G.711/PCM signal is utilized with compression for both enrollment and verification. In particular, the enrollment phase of FIG. 5 shows an embodiment providing that enrollment occurs in the steps of:

1) Input client device 15 outputs a digitized audio signal 18 to a network 20.

2) The network 20 sends the signal 18 to the compressor 24.

3) The compressor 24 sends a compressed signal 18 to the voice recorder 40.

4) The voice recorder 40 sends a compressed signal to the decompressor 26.

5) The decompressor 26 decompresses the signal 18 and sends the decompressed signal 18 to the biometrics engine 50.

6) The biometrics engine 50 operates on the signal and outputs at least one voice print, being illustrated as “voice print-1” 70, “voice print-2” 72 up to “voice print-N” 74.

Continuing with reference to the enrollment phase of FIG. 5, an embodiment provides that verification occurs in the steps of:

7) Input client device 15 having previously output a digitized audio signal 18 to a network 20, the network 20 sends the signal 18 to a compressor 24.

8) The compressor 24 sends a compressed signal 18 to the voice recorder 40.

9) The voice recorder 40 sends a compressed signal to the decompressor 26.

10) The decompressor 26 decompresses the signal 18 and sends the decompressed signal 18 to the biometrics engine 50.

11) The biometrics engine 50 operates on the signal and outputs a verification score 90 and a confidence score 95.

Consider once more novel FIG. 1B and the prior art of FIG. 2. In extending the prior art FIG. 2 baseline scenario 1 into the novel embodiments of FIG. 1B, all the embodiments of FIGS. 3 through 5, as scenarios 2-4, are readily extended.

I claim:

1. A System for Improving the Performance of Voice biometrics comprising,
A digitized audio signal,
One or more input client devices,
A compressor,
A voice recorder,
A decompressor, and,
A voice biometrics engine;

2. The system of claim 1 wherein the compressor is incorporated within the one or more input client devices.

3. The system of claim 1 further comprising a network.

4. The system of claim 1 further comprising the voice biometrics engine chosen from the group LVCSR, phonetics, text dependent, text independent.

5. The system of claim 3, the network selected from the group PSTN, ISDN, IP (VoIP), wired or wireless.

6. The system of claim 1, the compressor and the decompressor comprising MASC® technology.

7. The system of claim 1, the digitized audio signal selected from the group
1) PCM (with sampling rate selected from the group 8, 11, 16, 22, 32, 44, 48 KHz and bit resolution selected from the group 8, 16, 32, 64), G.711 (selected from the group a-law, u-law),
2) MASC® compressed and MASC® decompressed,
3) standards-based selected from the group; ITU-based: G.722, G.723, G.726, G.729; ETSI-based: GSM 6.10, GSM-AMR; CDMA-based: IS-95/CDMA-1x, IS-95/CDMA-3x; and EVDO-based: EVRC-A, EVRC-B, EVRC-AB, VMR.

8. The system of claim 7 including a standards-based decompressor, a compression engine (CODEC) comprising a compressor and a decompressor, and a signal processing filter.

9. The system of claim 8 wherein each of the standards-based decompressor, compressor, voice recorder, decompressor, signal processing filter, and voice biometrics engine are placed into separate groups, wherein each is in any of the separated groups and all the separated groups being either physically collocated or each of the separated groups being remotely located from the others.

10. The system of claim 9, wherein MASC® processing is combined with the signal processing filter and the signal processing filter is introduced between the decompressor and the biometrics engine.

11. A Method for Improving the Performance of Voice biometrics comprising the steps of:
(a) For enrollment, the biometrics engine receives a digitized audio signal, the signal being decompressed or uncompressed, from one or more input client devices, directly or through a network,
The compressor receives the signal from the input client device, directly or through a network, thereby compressing the signal and sends the compressed signal to a voice recorder,
The voice recorder sends the compressed signal to a decompressor which decompresses the signal,
The decompressor sends the decompressed signal to the biometrics engine, If the signal is uncompressed, the biometrics engine receives the signal from the input client device directly or through the network,
The biometrics engine performs speaker identification functions and outputs at least one voice print thereby completing the enrollment process; and,
(b) For verification, the biometrics engine receives a digitized audio signal, the signal being decompressed or uncompressed, to a biometrics engine directly or through a network,
The compressor receives the signal from the input client device, directly or through a network, thereby compressing the signal and sends the compressed signal to a voice recorder,
The voice recorder sends the compressed signal to a decompressor which decompresses the signal,
The decompressor sends the decompressed signal to the biometrics engine, If the signal is uncompressed, the biometrics engine receives the signal from the input client device directly or through the network,
The biometrics engine further provides a verification score and a confidence score wherein true and impostor scores are measured by False Acceptance Rate (FAR) and False Rejection Rate (FRR), further yielding an Equal Error Rate (EER).

12. The method of claim 11 further comprising the voice biometrics engine chosen from the group LVCSR, phonetics, text dependent, text independent.

13. The method of claim 11, the network selected from the group PSTN, ISDN, IP (VoIP), wired or wireless.

14. The method of claim 11, the compressor and the decompressor comprising MASC® technology.

15. The method of claim 11, the compressor being incorporated within the one or more input client devices.

16. The method of claim 11, the digitized audio signal selected from the group
1) PCM (with sampling rate selected from the group 8, 11, 16, 22, 32, 44, 48 KHz and bit resolution selected from the group 8, 16, 32, 64), G.711 (selected from the group a-law, u-law),
2) Proprietary compressed from the compressor and proprietary decompressed from the decompressor,
3) Standards-based selected from the group; ITU-based: G.722, G.723, G.726, G.729; ETSI-based: GSM 6.10, GSM-AMR; CDMA-based: IS-95/CDMA-1x, IS-95/CDMA-3x; and EVDO-based: EVRC-A, EVRC-B, EVRC-AB, VMR.

17. The method of claim 11, wherein the signal processing filter receives the decompressed signal from the decompressor and processes the decompressed signal thereby enhancing the voice quality, the signal processing filter forwarding the enhanced decompressed signal to the biometrics engine.

18. The method of claim 17, proprietary being selected from the group CELP-based, MASC®.

19. A Method for Improving the Performance of Voice biometrics comprising the steps of:
(a) For enrollment, the biometrics engine receives a decompressed digitized audio signal, the signal being standards-based or proprietary, from one or more input client devices, directly or through a network,
If the decompressed signal is proprietary, a standards-based decompressor receives the signal from the input client device, directly or through a network, thereby decompressing the standards-based signal and sends the decompressed signal to a compressor,
The compressor compresses the signal and sends the signal to a voice recorder,
The voice recorder sends the compressed signal to a decompressor which decompresses the signal,
The decompressor sends the decompressed signal to a signal processing filter,
The signal processing filter sends the signal to a biometrics engine,
If the decompressed signal is standards-based, the biometrics engine receives the decompressed signal from the input client device directly or through the network, The biometrics engine performs speaker identification functions and outputs at least one voice print thereby completing the enrollment process; and,
(b) For verification, the biometrics engine receives a decompressed digitized audio signal, the signal being standards-based or proprietary, from one or more input client devices, directly or through a network,
If the decompressed signal is proprietary, a standards-based decompressor receives the signal from the input client device, directly or through a network, thereby decompressing the standards-based signal and sends the decompressed signal to a compressor,
The compressor compresses the signal and sends the signal to a voice recorder,
The voice recorder sends the compressed signal to a decompressor which decompresses the signal,
The decompressor sends the decompressed signal to a signal processing filter,
The signal processing filter sends the signal to a biometrics engine,
If the decompressed signal is standards-based, the biometrics engine receives the decompressed signal from the input client device directly or through the network, The biometrics engine further provides a verification score and a confidence score wherein true and impostor scores are measured by False Acceptance Rate (FAR) and False Rejection Rate (FRR), further yielding an Equal Error Rate (EER).

20. The method of claim 19 wherein each of the standards-based decompressor, compressor, voice recorder, decompressor, signal processing filter, and voice biometrics engine are placed into separate groups, wherein each is in any of the separated groups and all the separated groups being either physically collocated or each of the separated groups being remotely located from the others.
